(19) United States
(12) Patent Application Publication
(10) Pub. No.: US 2011/0267432 A1
(43) Pub. Date: Nov. 3, 2011

(54) CAMERA AND CAMERA SYSTEM

(75) Inventor: Yuji KUMAKURA, Hyogo (JP)

(73) Assignee: PANASONIC CORPORATION, Osaka (JP)

(21) Appl. No.: 13/005,155

(22) Filed: Jan. 12, 2011

(30) Foreign Application Priority Data
Jan. 13, 2010 (JP) 2010-004711

(51) Int. Cl. H04N 13/02

(52) U.S. Cl. 348/47; 348/E13.074

(57) ABSTRACT

A camera system includes a first camera, a second camera, a detachable mechanism capable of attaching and detaching the first and second cameras to and from each other. The first camera has a first lens barrel having a first optical axis, and configured to form a first optical image, and a first imaging device configured to receive the first optical image to generate an electrical image signal. The second camera has a second lens barrel having a second optical axis different from the first optical axis and configured to form a second optical image, and a second imaging device configured to receive the second optical image to generate an electrical image signal. When the first and second cameras simultaneously or successively perform shooting, an angle of view of the first lens barrel is wider than that of the second lens barrel.

### CROSS-REFERENCE TO RELATED APPLICATION

This application claims priority to Japanese Patent Application No. 2010-004711 filed on Jan. 13, 2010, the disclosure of which including the specification, the drawings, and the claims is hereby incorporated by reference in its entirety.

### BACKGROUND

A technique disclosed herein relates to cameras and camera systems including the same.

Conventionally, cameras such as digital still cameras and video cameras are known in the art, and nowadays, such cameras are widely used. These cameras are basically configured to shoot two-dimensional (2D) images.

Three-dimensional (3D) display is becoming increasingly common which stereoscopically display an image by using two images having parallax therebetween. Thus, there has been a growing demand for cameras capable of shooting images (hereinafter also simply referred to as “3D images”) to be viewed as stereoscopic images.

One such camera for shooting 3D images is disclosed in Japanese Patent Publication No. 2003-092771. The camera of Japanese Patent Publication No. 2003-092771 has two optical axes, namely first and second optical axes, and includes shutters and mirrors, which are provided on the optical axes, respectively, and a prism, a lens, and a charge coupled device (CCD), which are common to the two optical axes. Light beams are reflected by the mirrors on the first and second optical axes into the prism. The light beams thus incident on the prism are reflected by the prism into the lens, and the lens forms an image on the CCD. Thus, an optical image on the first optical axis and an optical image on the second optical axis are shot by the single CCD. For example, the optical image on the first optical axis serves as a right eye image, the optical image on the second optical axis serves as a left eye image, and a 3D image is formed by these images. A known 3D image display apparatus displays the 3D image, thereby providing a stereoscopic image.

### SUMMARY

However, the camera of Japanese Patent Publication No. 2003-092771 incorporates a mechanism for shooting a right eye image and a left eye image, as described above. Thus, the camera of Japanese Patent Publication No. 2003-092771 can shoot 3D images, but cannot shoot 2D images. Accordingly, separate cameras are required to shoot both 3D and 2D images.

The disclosed technique has been developed in view of the above problem, and it is an object of the disclosed technique to shoot 3D images in a simple manner by using a camera capable of obtaining 2D images.

The disclosed technique is directed to a camera system including first and second cameras. The camera system further includes a detachable mechanism capable of attaching and detaching the first and second cameras to and from each other. The first camera has a first lens barrel having a first optical axis and configured to form a first optical image, and a first imaging device configured to receive the first optical image to generate an electrical image signal. The second camera has a second lens barrel having a second optical axis different from the first optical axis and configured to form a second optical image, and a second imaging device configured to receive the second optical image to generate an electrical image signal. When the first and second cameras simultaneously or successively perform shooting, an angle of view of the first lens barrel is wider than that of the second lens barrel.

The disclosed technique is also directed to a camera including a first lens barrel having a first optical axis and configured to form a first optical image, and a first imaging device configured to receive the first optical image to generate an electrical image signal. The camera further includes a detachable mechanism capable of attaching and detaching the camera to and from a second camera. The second camera has a second lens barrel having a second optical axis different from the first optical axis and configured to form a second optical image, and a second imaging device configured to receive the second optical image to generate an electrical image signal. When the camera and the second camera simultaneously or successively perform shooting, an angle of view of the first lens barrel is wider than that of the second lens barrel.

According to the above camera system, a 2D image can be shot by the second camera, and a 3D image can be shot in a simple manner by attaching the first camera to the second camera.

According to the above camera, a 3D image can be shot in a simple manner by attaching the camera to the second camera capable of shooting a 2D image.

### BRIEF DESCRIPTION OF THE DRAWINGS

FIG. 1 is a perspective view of a camera system of an embodiment.

FIG. 2 is a front view of the camera system when shooting a 3D image.

FIG. 3 is a block diagram of the camera system.

FIG. 4 is a flowchart illustrating the operation that is performed when shooting a 3D image.

FIG. 5 is a flowchart illustrating recording processing.

FIG. 6 is a schematic view of an image shot by a main camera.

FIG. 7 is a schematic view of an image shot by a sub camera.

FIG. 8 is a front view showing the state of a camera system of another embodiment when shooting a 3D image.

FIG. 9 is a schematic view of an image shot by a main camera of the another embodiment.

FIG. 10 is a schematic view of an image shot by a sub camera of the another embodiment.

### DETAILED DESCRIPTION

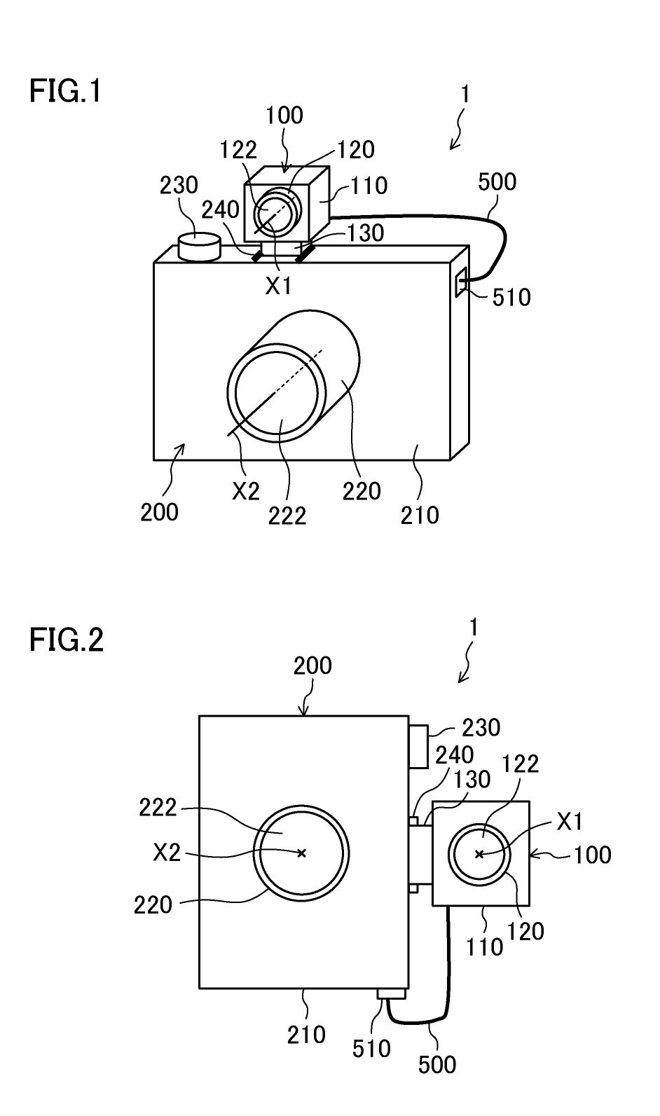

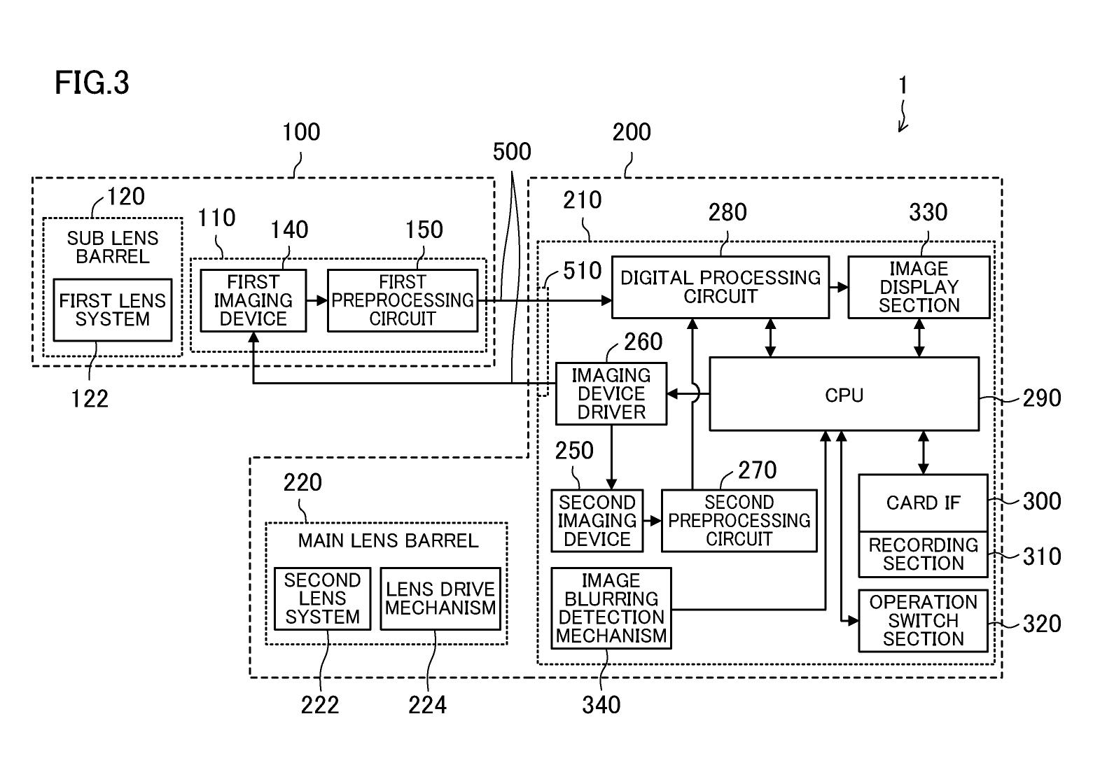

Example embodiments will be described in detail below with reference to the accompanying drawings. FIG. 1 is a perspective view of a camera system of an embodiment, FIG. 2 is a front view of the camera system when shooting a 3D image, and FIG. 3 is a block diagram of the camera system.

A camera system 1 of the embodiment includes a sub camera 100 and a main camera 200.

The main camera 200 includes a camera main body 210, a main lens barrel 220 attached to the front face of the camera main body 210, a release button 230 provided on the upper face of the camera main body 210, a hot shoe 240 provided on the upper face of the camera main body 210, and an external input/output (I/O) terminal 510 provided on a side face of the camera main body 210. The main camera 200 forms a second camera. The hot shoe 240 forms a detachable mechanism of the main camera 200.

The camera main body 210 has a second imaging device 250 formed by a charge coupled device (CCD) or a complementary metal oxide semiconductor (CMOS) device. The second imaging device 250 converts an optical image on its imaging plane to an electrical image signal. The main lens barrel 220 is an interchangeable lens barrel, and is detachable from the camera main body 210. The main lens barrel 220 forms a second lens barrel. The main lens barrel 220 includes a lens system (hereinafter also referred to as the “second lens system”) 222 formed by a plurality of lenses. The second lens system 222 has a predetermined optical axis (hereinafter also referred to as the “second optical axis”) X2. The second optical axis X2 passes through the imaging plane (specifically, its center) of the second imaging device 250. The second lens system 222 forms an image of a subject on the imaging plane of the second imaging device 250. The second lens system 222 is formed by a zoom lens and a focus lens. The release button 230 is one of operation buttons provided on the outer surface of the camera main body 210, and is a button for sending a command to the main camera 200 and the sub camera 100 to execute a series of shooting sequences. The hot shoe 240 is a mechanical and electrical connection portion for attaching an external flash, an electronic viewfinder, etc. The hot shoe 240 has an electrical contact point, and can supply electricity to an apparatus that is attached to the hot shoe 240.

The sub camera 100 includes a camera main body 110, a sub lens barrel 120 attached to the front face of the camera main body 110, an attachment portion 130 detachable from the hot shoe 240 of the main camera 200, and a cable 500 capable of being connected to the external I/O terminal 510 of the main camera 200. The overall size of the sub camera 100 is smaller than that of the main camera 200. The attachment portion 130 forms a detachable mechanism of the sub camera 100.

The camera main body 110 has a first imaging device 140 formed by a CCD or a CMOS device. The first imaging device 140 converts an optical image on its imaging plane to an electrical image signal. The sub lens barrel 120 includes a lens system (hereinafter also referred to as the “first lens system”) 122 formed by a plurality of lenses. The sub lens barrel 120 forms a first lens barrel. The sub lens system 122 has a predetermined optical axis (hereinafter also referred to as the “first optical axis”) X1. The first optical axis X1 passes through the imaging plane (specifically, its center) of the first imaging device 140. The first lens system 122 forms an image of the subject on the imaging plane of the first imaging device 140. The first lens system 122 is formed by a single focus lens. The focal length of the first lens system 122 is shorter than that of the second lens system 222. That is, the angle of view of the first lens system 122 is wider than the maximum angle of view of the second lens system 222 (that is, the angle of view that is obtained when the zoom lens of the main lens barrel 220 is positioned on the widest angle end). For example, the angle of view of the first lens system 122 exceeds 60 degrees. The first lens system 122 has a great depth of field due to its short focal length, and thus focus adjustment is less necessary for the first lens system 122.

The sub camera 100 is detachable from the main camera 200 via the attachment portion 130 and the hot shoe 240. When the sub camera 100 is attached to the main camera 200, and the main camera 200 is held horizontally (in the state where the longitudinal direction of the imaging plane of the second imaging device 250 matches the horizontal direction), the first optical axis X1 is located substantially vertically above the second optical axis X2. The sub camera 100 is electrically connected to the main camera 200 via the attachment portion 130 and the hot shoe 240. Moreover, the cable 500 is connected to the external I/O terminal 510 of the main camera 200. Thus, the sub camera 100 can transmit and receive signals to and from the main camera 200. The cable 500 may be configured to be detachable from the sub camera 100, or may be configured to be pulled out of the sub camera 100.

When shooting a 3D image by using the camera system 1 thus configured, the main camera 200 is held vertically (in the state where the longitudinal direction of the imaging plane of the second imaging device 250 matches the vertical direction). That is, when shooting a 3D image, the sub lens barrel 120 and the main lens barrel 220, namely the first optical axis X1 and the second optical axis X2, are located next to each other in the horizontal direction. Two images having binocular parallax therebetween can be obtained by performing shooting in this state.

The configuration of the sub camera 100 and the main camera 200 will be described in detail below.

The camera main body 110 of the sub camera 100 has a first preprocessing circuit 150 in addition to the first imaging device 140. The first imaging device 140 is controlled by an imaging device driver 260, described later, of the main camera 200. The first imaging device 140 outputs an obtained electrical signal to the first preprocessing circuit 150. The first preprocessing circuit 150 is a processing circuit including a gain control amplifier, an analog-to-digital (A/D) converter, etc. The first preprocessing circuit 150 adjusts the gain of the electrical signal received from the first imaging device 140, and converts the resultant electrical signal to a digital signal. The first preprocessing circuit 150 outputs this digital signal to the main camera 200 via the cable 500.

The main lens barrel 220 of the main camera 200 has, in addition to the second lens system 222, an aperture mechanism (not shown), and a lens drive mechanism 224 for driving the focus lens and the zoom lens of the second lens system 222 and the aperture mechanism. The lens drive mechanism 224 is formed by a drive mechanism such as a stepping motor. The main lens barrel 220 is electrically connected to the camera main body 210. Lens information such as the focal length and the aperture of the main lens barrel 220 is read by a central processing unit (CPU) 290, described later, of the camera main body 210.

In addition to the second imaging device 250, the camera main body 210 of the main camera 200 has: the imaging device driver 260 for controlling the first and second imaging devices 140, 250; a second preprocessing circuit 270 for performing predetermined signal processing on an electrical signal from the second imaging device 250; a digital processing circuit 280 for performing predetermined signal processing on digital signals from the first and second preprocessing circuits 150, 270; the CPU 290 having primary control over the camera main body 210; a recording section 310 formed by a memory card; a card interface 300 that enables data to be transmitted between the recording section 310 and the CPU 290; an operation switch section 320 formed by various switches that are turned on/off according to the operation of the operation buttons (such as the release button 230) provided on the outer surface of the camera main body 210; an image display section 330 for displaying image data as a visible image; and an image blurring detection mechanism 340 for detecting image blurring.

The imaging device driver 260 separately controls the first imaging device 140 and the second imaging device 250. The second imaging device 250 outputs an obtained electrical signal to the second preprocessing circuit 270.

The second preprocessing circuit 270 is a processing circuit including a gain control amplifier, an A/D converter, etc. The second preprocessing circuit 270 adjusts the gain of the electrical signal received from the second imaging device 250, and converts the resultant electrical signal to a digital signal. The second preprocessing circuit 270 outputs this digital signal to the digital processing circuit 280.

In addition to the digital signal from the second preprocessing circuit 270, the digital processing circuit 280 receives the digital signal transmitted from the first preprocessing circuit 150 to the main camera 200 via the cable 500. The digital processing circuit 280 performs image processing, such as processing of generating a color signal, on the digital signals from the first and second preprocessing circuits 150, 270 to generate two pieces of image data. Then, the digital processing circuit 280 generates 3D image data from the two pieces of image data.

Note that if the sub camera 100 is not connected to the main camera 200, the digital processing circuit 280 generates 2D image data based only on the digital signal from the second preprocessing circuit 270.

The recording section 310 stores the 3D image data and the 2D image data that are output from the digital processing circuit 280.

The image display section 330 has a liquid crystal display (LCD) monitor, a control circuit for controlling the LCD motor, etc. The image display section 330 displays an image based on the image data that is output from the digital processing circuit 280.

The image blurring detection mechanism 340 is formed by a vibratory gyroscope, and detects vibration of the camera main body 210 caused by shaking of the operator's hand, etc. The image blurring detection mechanism 340 outputs a detection signal to the CPU 290. The image blurring detection mechanism 340 can also be used to detect the attitude of the main camera 200. That is, the CPU 290 determines if the main camera 200 is held vertically, based on the output signal of the image blurring detection mechanism 340. Note that although the image blurring detection mechanism 340 is used to detect the attitude of the main camera 200 in the present embodiment, the present invention is not limited to this. A separate dedicated sensor may be provided to detect the attitude of the main camera 200.

The CPU 290 controls the imaging device driver 260, the digital processing circuit 280, the recording section 310, the operation switch section 320, and the image display section 330 to perform various kinds of processing.

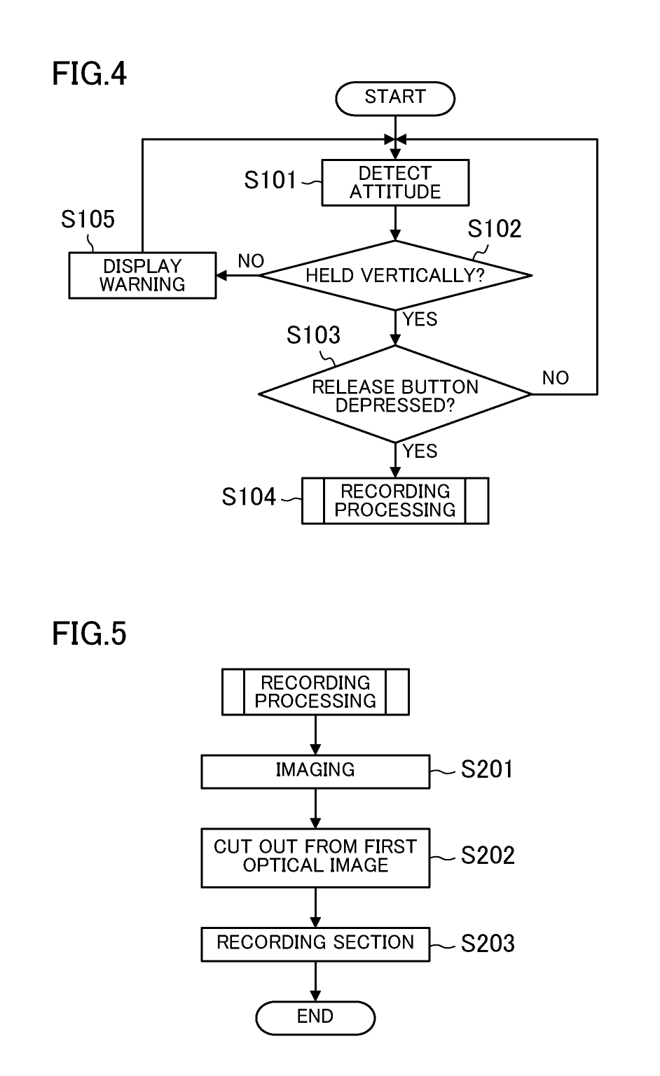

The operation that is performed when shooting a 3D image will be described below. FIG. 4 is a flowchart illustrating the operation that is performed when shooting a 3D image.

First, the CPU 290 of the main camera 200 detects the attitude of the main camera 200 (step S101). Specifically, the CPU 290 reads an output signal of the image blurring detection mechanism 340. Then, the CPU 290 determines if the main camera 200 is held vertically (step S102).

If the main camera 200 is held vertically, the CPU 290 switches the release button 230 to a depressible state, and waits for the release button 230 to be depressed (step S103). The depressible state is the state where the CPU 290 can accept depression of the release button 230, and where the CPU 290 performs shooting in response to the depression of the release button 230. If the release button 230 is not in the depressible state, the CPU 290 does not perform shooting even if the release button 230 is depressed. When the operator depresses the release button 230, the CPU 290 performs shooting and recording processing (S104). The recording processing will be described in detail later. Note that if the release button 230 is not depressed during a predetermined period of time, the CPU 290 returns to step S101 to detect the attitude of the main camera 200.

On the other hand, if the main camera 200 is not held vertically, the CPU 290 displays a warning on the image display section 330 (step S105). After displaying a warning, the CPU 290 returns to step S101 to detect the attitude of the main camera 200 again. Note that although the warning that the main camera 200 is not held vertically is displayed on the image display section 330 in the present embodiment, the present invention is not limited to this. A warning tone may serve as the warning, or a warning light that is provided on the outer surface of the main camera 200 or the sub camera 100 may be turned on as the warning.

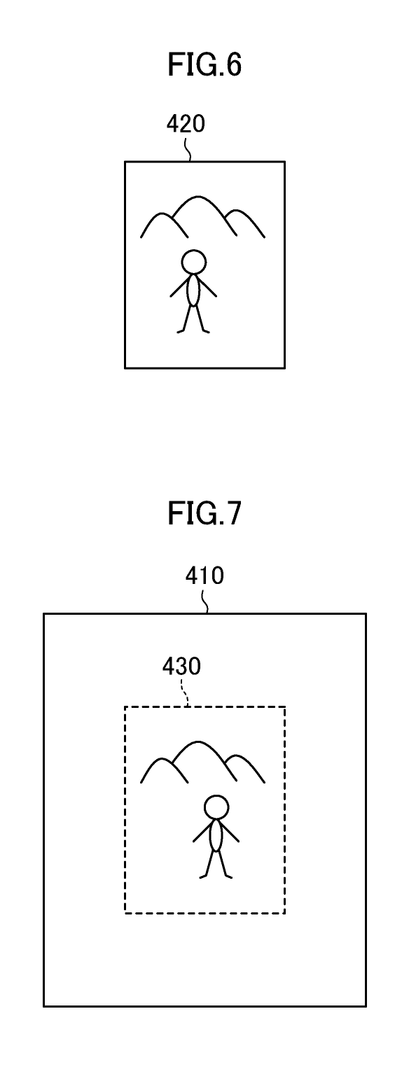

The recording processing that is performed upon shooting will be described in detail below. FIG. 5 is a flowchart illustrating the recording processing, FIG. 6 is a schematic view of an image shot by the main camera 200, and FIG. 7 is a schematic view of an image shot by the sub camera 100.

When the release button 230 is depressed, the CPU 290 first allows the second imaging device 250 of the main camera 200 and the first imaging device 140 of the sub camera 100 to perform shooting (S201). A second optical image 420 that is shot by the second imaging device 250 is converted to an electrical signal by the second imaging device 250, and then, image data is generated from the electrical signal via the second preprocessing circuit 270 and the digital processing circuit 280, and is recorded in the recording section 310 (S203). A first optical image 410 that is shot by the first imaging device 140 is converted to an electrical signal by the first imaging device 140, and then, image data is generated from the electrical signal via the first preprocessing circuit 150 and the digital processing circuit 280. The digital processing circuit 280 cuts out a portion corresponding to the second optical image 420, namely a third optical image 430, from the first optical image 410, and generates image data of the third optical image 430 (S202). Then, the image data of the third optical image 430 is recorded in the recording section 310 (S203). As the sub camera 100 and the main camera 200 have different optical axes from each other, the first and second optical images 410, 420 have parallax therebetween. Thus, the third optical image 430 cut out from the first optical image 410 also has parallax with respect to the second optical image 420. Two pieces of image data having parallax therebetween are obtained in this manner. Note that the second optical image 420 is a right eye image, and the third optical image 430 is a left eye image.

Generation of the image data of the third optical image 430 will be described in more detail below.

As a right eye image and a left eye image together form a single 3D image, the shooting range of the right eye image needs to be the same as that of the left eye image. However, the shooting range of the image that is shot by the first imaging device 140 is not necessarily the same as that of the image that is shot by the second imaging device 250. For example, if the shooting magnification of the sub lens barrel 120 is different from that of the main lens barrel 220, the shooting range of the first imaging device 140 is different from that of the second imaging device 250.

Thus, the digital processing circuit 280 cuts out the third optical image 430 corresponding to the shooting range of the second optical image 420, from the first optical image 410. Specifically, the digital processing circuit 280 determines a range (a cut-out range) to be cut out from the first optical image 410 based on magnification information of the main lens barrel 220 upon shooting. If an effective region (a region where imaging can be performed in an imaging plane) of the first imaging device 140 is the same as that of the second imaging device 250, “FLs” represents the focal length of the sub lens barrel 120, and “FLm” represents the focal length of the main lens barrel 220, the dimensions of the cut-out range of the first optical image 410 is “FLs/FLm” times the overall dimensions of the first optical image 410. For example, if the focal length “FLm” of the main lens barrel 220 is three times the focal length “FLs” of the sub lens barrel 120, the dimensions of the cut-out range of the first optical image 410 is one third of the overall dimensions of the first optical image 410. That is, the area of the cut-out range is 1/9 times that of the first optical image 410. Even if the main lens barrel 220 is exchanged with another one, the cut-out range of the first optical image 410 is determined based on lens information of the another main lens barrel 220.

The digital processing circuit 280 also determines a portion (a cut-out portion) to be cut out from the first optical image 410. The cut-out portion of the first optical image 410 is determined based on a common feature portion of the first and second images 410, 420. Specifically, the digital processing circuit 280 extracts the common feature portion from each of the first and second optical images 410, 420, and determines the cut-out portion of the first optical image 410 based on the extracted feature portion. For example, in the example of FIGS. 6-7, mountains behind a person are extracted as the common feature portion, and the third optical image 430 is cut out so that the position of the mountains in the third optical image 430 matches that of the mountains in the second optical image 420.

Image data of the second and third optical images 420, 430 having the same shooting range and having the common subject is generated in this manner. A 3D image display apparatus displays the second and third optical images 420, 430, thereby providing a stereoscopic image to the viewer. Note that if the image display section 330 is formed by a display apparatus capable of stereoscopically displaying 3D images, the image display section 330 is allowed to stereoscopically display the second and third optical images 420, 430.

According to the present embodiment, the sub camera 100 configured to shoot 2D images is attached to the main camera 200 that is originally configured to shoot 2D images, thereby making it possible to shoot 3D images in a simple manner. When desired, a 2D image can be shot by the main camera 200 by detaching the sub camera 100 from the main camera 200. Thus, either a 2D or 3D image can be easily shot as desired by attaching or detaching the sub camera 100 to or from the main camera 200. The main camera 200 is a common fundamental device that is used both when shooting a 2D image and when shooting a 3D image, and the sub camera 100 need only be attached to the main camera 200 when shooting a 3D image. Thus, it is not necessary to prepare separate cameras to shoot 2D and 3D images, which can increase convenience for the operator.

The second optical image 420 obtained when shooting a 3D image is a 2D image that is supposed to be shot by the main camera 200. Thus, even when shooting a 3D image, a 2D image can be shot while using the original capability of the main camera 200. That is, a high quality 2D image can be shot simultaneously with a 3D image.

The position to which the sub camera 100 is attached can vary depending on the shape of the main camera 200. However, as the sub camera 100 uses a relatively wide angle lens system, the sub camera 100 can be attached to various kinds of main cameras 200 to shoot a 3D image.

A structure for attaching and detaching the sub camera 100 can be simplified by using the hot shoe 240 to attach the sub camera 100 to the main camera 200. That is, since typical cameras for shooting 2D images have a hot shoe, the sub camera 100 can be made detachable from such conventional cameras with no special remodeling thereof. Moreover, as the hot shoe 240 is capable of supplying electricity, the hot shoe 240 can be used to supply electricity to the sub camera 100.

Furthermore, the attitude of the main camera 200, namely whether or not the first optical axis X1 of the first lens system 122 and the second optical axis X2 of the second lens system 222 are appropriately positioned, is detected, and a warning is provided if the first and second optical axes X1, X2 are not appropriately positioned. This can reduce the possibility of shooting the second optical image 420 having no parallax with respect to the first optical image 410, and thus can reduce the possibility of failure when shooting a 3D image.

### Other Embodiments

The above embodiment may be configured as follows.

Although the sub camera 100 is attached to the hot shoe 240 of the main camera 200, the present invention is not limited to this. The sub camera 100 may be configured to be attached to an accessory shoe (a so-called cold shoe) of the main camera 200 having no electrical contact. Alternatively, the structure for attaching the sub camera 100 to the main camera 200 is not limited to the accessory shoe, and any structure can be used as long as the sub camera 100 can be attached to the main camera 200.

Although the shooting timing of the sub camera 100 is controlled by the main camera 200, the present invention is not limited to this. For example, the sub camera 100 may have a release button, and may perform shooting in response to depression of the release button by the operator. In this case, a 3D image is shot when the operator substantially simultaneously or successively depresses the release button 230 of the main camera 200 and the release button of the sub camera 100.

Although the angle of view of the first lens system 122 is wider than the maximum angle of view of the second lens system 222, the present invention is not limited to this. The maximum angle of view of the second lens system 222 may be wider than the angle of view of the first lens system 122. In this case, however, it is preferable to limit movement of the zoom lens of the main lens barrel 220 when shooting a 3D image, so that the angle of view of the second lens system 222 does not become wider than that of the first lens system 122.

In the above embodiment, the third optical image 430 as a left eye image is generated from the first optical image 410 shot by the sub camera 100. However, a method for generating a 3D image is not limited to this. For example, a comparison is made between the common subject images of the first optical image 410 shot by the sub camera 100 and the second optical image 420 shot by the main camera 200, and a shift amount therebetween is obtained. Based on the obtained shift amount, the subject image of the second optical image 420 is shifted to generate the third optical image 430 as a left eye image. That is, the third optical image 430 is generated from the second optical image 420. A 3D image can also be generated by this method.

Note that a 3D image need not necessarily be generated by using the main camera 200. That is, the main camera 200 may merely shoot and record the first and second optical images 410, 420, and may not necessarily generate a 3D image. In this case, the first and second optical images 410, 420 may be read into an external apparatus such as a personal computer to generate a 3D image on the external apparatus.

Although the second lens system 222 is formed by the zoom lens and the focus lens, and the first lens system 122 is formed by the single focus lens in the above embodiment, the present invention is not limited to this. The first and second lens systems 122, 222 may be formed by any lenses or any combinations thereof. For example, the second lens system 222 may be formed by a single focus lens, and the first lens system 122 may be formed by a zoom lens. The main lens barrel 220 is not limited to an interchangeable lens barrel, and may be a lens barrel fixed to the camera main body 210.

Although communication between the sub camera 100 and the main camera 200 is implemented by the cable 500 extending from the sub camera 100 and the external I/O terminal 510 provided in the main camera 200, the present invention is not limited to this. Any configuration can be used as long as the communication between the sub camera 100 and the main camera 200 can be implemented. For example, the communication between the sub camera 100 and the main camera 200 may be implemented by a cable extending from the main camera 200 and an external I/O terminal provided in the sub camera 100. Alternatively, the communication between the sub camera 100 and the main camera 200 may be implemented by using a short-range wireless technique such as Bluetooth.

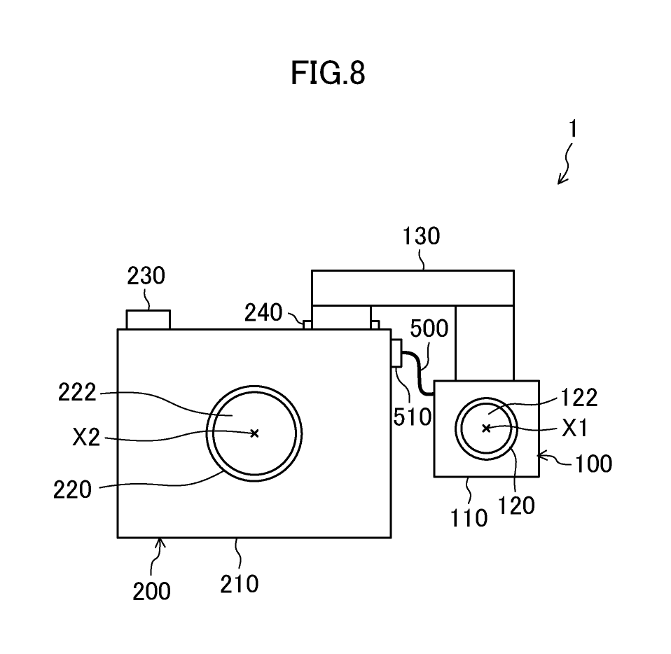

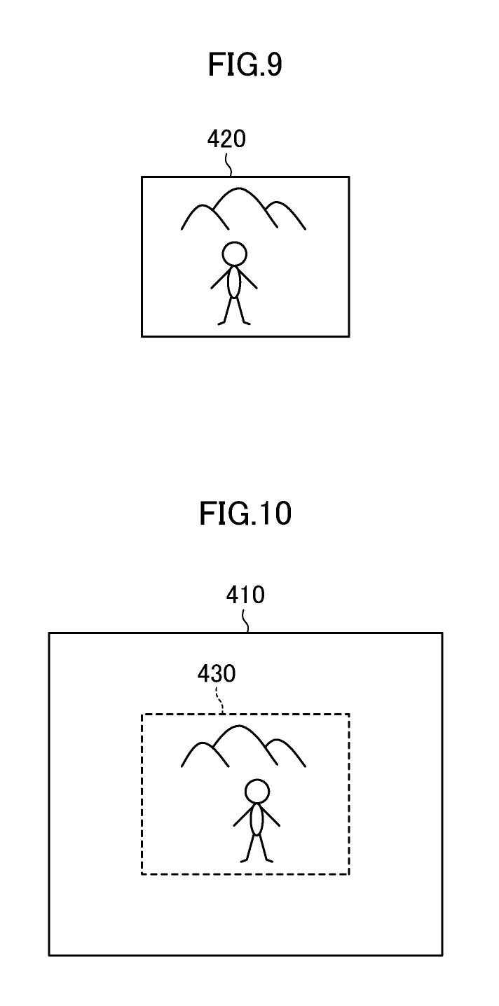

In the above embodiment, the sub camera 100 is attached to the main camera 200 so that the first optical axis X1 is located vertically above the second optical axis X2 when the main camera 200 is held horizontally. However, the present invention is not limited to this. For example, as shown in FIG. 8, the sub camera 100 may be attached to the main camera 200 so that the first and second optical axes X1, X2 are located next to each other in the horizontal direction when the main camera 200 is held horizontally. Specifically, the attachment portion 130 of the sub camera 100 may be shaped so that the attachment portion 130 extends upward from the hot shoe 240 of the main camera 200, is then bent laterally and extends horizontally, and is bent downward and extends downward. By attaching the sub camera 100 to the hot shoe 240 of the main camera 200 via such an attachment portion 130, the first and second optical axes X1, X2 can be located next to each other in the horizontal direction. In this configuration, the main camera 200 can be held horizontally when performing shooting. This makes it easier to keep the first and second optical axes X1, X2 located next to each other in the horizontal direction when shooting is performed, whereby two images having parallax therebetween can be easily shot. In this case, as shown in FIGS. 9-10, the first and second optical images 410, 420 are longer in the lateral direction than in the vertical direction. Since the third optical image 430 is generated by cutting out a portion corresponding to the second optical image 420 from the first optical image 410, the third optical image 430 is also longer in the lateral direction than in the vertical direction.

In the above embodiment, the main camera 200 performs image processing on the signal obtained by the first imaging device 140. However, the sub camera 100 may perform image processing on this signal. For example, the sub camera 100 may be provided with a digital processing circuit corresponding to the digital processing circuit 280. The digital processing circuit of the sub camera 100 may perform image processing on the digital signal from the first preprocessing circuit 150, or may perform image processing on the digital signals from the first and second preprocessing circuits 150, 270.

As described above, the present invention is useful for cameras and camera systems.

The present invention is not limited to the above embodiments, and may be embodied in various other forms without departing from the spirit or main features of the present invention. Thus, the above embodiments are provided by way of example only, and should not be construed as limiting the present invention. The scope of the present invention is defined by the claims rather than the foregoing description. All changes and modifications that come within the meaning and range of equivalence of the claims are to be embraced within the scope of the present invention.

What is claimed is:

1. A camera system including first and second cameras, comprising:
a detachable mechanism capable of attaching and detaching the first and second cameras to and from each other, wherein
the first camera has a first lens barrel having a first optical axis and configured to form a first optical image, and a first imaging device configured to receive the first optical image to generate an electrical image signal,
the second camera has a second lens barrel having a second optical axis different from the first optical axis and configured to form a second optical image, and a second imaging device configured to receive the second optical image to generate an electrical image signal, and
when the first and second cameras simultaneously or successively perform shooting, an angle of view of the first lens barrel is wider than that of the second lens barrel.

2. A camera including a first lens barrel having a first optical axis and configured to form a first optical image, and a first imaging device configured to receive the first optical image to generate an electrical image signal, comprising:
a detachable mechanism capable of attaching and detaching the camera to and from a second camera, where the second camera has a second lens barrel having a second optical axis different from the first optical axis and configured to form a second optical image, and a second imaging device configured to receive the second optical image to generate an electrical image signal, wherein
when the camera and the second camera simultaneously or successively perform shooting, an angle of view of the first lens barrel is wider than that of the second lens barrel.
